(19) United States
(12) Patent Application Publication
(10) Pub. No.: US 2017/0267508 A1
(43) Pub. Date: Sep. 21, 2017

(54) WORKS MACHINE COMPRISING MORE RELIABLE MEANS OF NEUTRALIZING A SAFETY DEVICE

(71) Applicant: HAULOTTE GROUP, L'Horme (FR)

(72) Inventors: Emmanuel HUBER, OULLINS (FR); Gaetan GODINEAU, ORLIENAS (FR)

(21) Appl. No.: 15/532,245

(22) PCT Filed: Nov. 25, 2015
(86) PCT No.: PCT/EP2015/077651

§ 371 Date: Jun. 1, 2017

(30) Foreign Application Priority Data
Dec. 3, 2014 (FR) 1461873

(51) Int. Cl. B66F 17/00; G05B 9/02; B66F 11/04

(52) U.S. Cl. CPC B66F 17/006; B66F 11/044; G05B 9/02

(57) ABSTRACT

The works machine (10) includes safety devices (30), able to switch the machine (10) from a normal operating state to a safety shutdown state, a unit (32) for neutralizing this safety shutdown state, including an activation element able to switch the machine (10) from the safety shutdown state to a forced operation state, and an auxiliary unit controlling the machine (10) able to command the machine (10) in the forced operation state when they are actuated. The neutralizing unit (32) include a computer device (34) including: the activation element, a memory device (50), and a unit (52) for recording, in the memory device (50), information according to which the activation element has been actuated.

The present invention relates to a works machine comprising more reliable means of neutralizing a safety device.

More particularly, the invention relates to a lifting device, but could be extended to any works machine capable of entering a safety shutdown state.

Already known, in the state of the art, is a works machine, in particular a lifting device, including a safety device, able to switch the machine from a normal operating state to a safety shutdown state, and a device for neutralizing this safety shutdown state, comprising an activation element able to switch the machine from the safety shutdown state to a forced operation state, and auxiliary means of controlling the machine able to command the machine to enter the forced operation state.

In the case of a lifting device including a lifting platform, a user present on the platform may suffer uneasiness or an accident, and then be incapable of controlling the lifting device himself to return to the ground. In this situation, a safety device of the machine, such as an emergency shutdown device or a load limiter, is frequently actuated, to switch from a normal operating state to a safety shutdown state.

In the case of such a safety shutdown, it is necessary to be able to rescue the user located on the platform, by returning the platform to the ground or to within reach of the ground.

To that end, the neutralizing device is generally arranged to be accessible from the ground and makes it possible to control the platform, in order to bring it within reach to rescue the user despite the safety shutdown state.

According to standard EN280-2013, it is required to provide devices for protecting against incorrect use of the neutralizing device and to provide a visual indication of its use.

To that end, in the state of the art, it is provided that the activation element is formed by a dedicated and sealed switch. However, such a switch is not fully satisfactory.

Indeed, the absence of a seal does not necessarily mean that the neutralizing device has been activated. Conversely, it is easy to replace a seal after activating the neutralizing device, such that the presence of a seal does not necessarily mean that the neutralizing device has not been activated.

Thus, the visible indication of the use of the neutralizing device is not completely reliable.

The invention in particular aims to resolve this drawback by proposing a works machine with more reliable monitoring of the use of the neutralizing device.

To that end, the invention in particular relates to a works machine with an aerial lift, including:
safety devices, able to switch the machine from a normal operating state to a safety shutdown state,
a platform equipped with primary control means, able to control the machine in the normal operating state,
means for neutralizing the safety shutdown state, comprising an activation element, able to switch the machine from the safety shutdown state to a forced operation state when it is actuated, and
auxiliary control means of the machine, able to be manipulated from the ground, capable of controlling the machine in the forced operating state when they are actuated,
   characterized in that the neutralizing means include a computer device comprising:
the activation element,
a memory device, and
means for recording, in the memory device, information according to which the activation element has been actuated.

The neutralizing means according to the invention, also called override means, allow recording, in the memory device, of information when the activation element has been actuated. This information can be binary (indicating only whether the activation element has been actuated) or include other indications, such as the date and time of the activation.

This information cannot be recorded without actuating the activation element, and cannot be deleted easily. In other words, the reliability of the neutralizing means according to the invention is enhanced, while resolving the problems raised by those of the state of the art.

Advantageously, the recording means are configured to record the information in the memory device only when the activation element and the auxiliary control means have both been actuated.

Thus, the information is recorded in the memory device only when a command from the machine has in fact been carried out owing to the neutralizing means. Such a distinction is not possible in the state of the art, where the only available information is the presence or absence of the seal, which does not make it possible to presuppose the actual use of the neutralizing means. A works machine according to the invention can further comprise one or more of the following features, considered alone or in any technically possible combinations.
The computer device includes a display screen and a man/machine interface.
The computer device includes means for displaying information according to which the activation element and/or the auxiliary control means have been actuated.
The neutralizing means are powered by a power source via a connection able to be maintained even in case of safety shutdown of the machine, and in particular when the safety shutdown state is caused by an emergency shutdown switch.
The safety devices include: a load limiter, able to switch the machine from the normal operating state to the safety shutdown state when the mass of the load exceeds a predetermined value, and/or a user safety device, able to switch the machine from the normal operating state to the safety shutdown state when a loss of consciousness of the user is detected, and/or at least one emergency stop switch, able to switch the machine from the normal operating state to the safety shutdown state when it is actuated.
The information recorded in the memory device indicates: whether the safety shutdown state was caused by the load limiter, the user safety device or the switch, and/or on what date and/or at what time the activation element and/or the auxiliary control means were actuated, and/or what movements were made by the auxiliary control means.

The invention also relates to a method for neutralizing a safety shutdown state of a works machine as previously defined, characterized in that it includes:
a step for actuating the activation element, and
a step for recording, in the memory device, information according to which the activation element has been actuated.

Advantageously, the neutralizing method includes, after the step for actuating the activation element, a step for activating auxiliary control means, and wherein the recording step follows the activation step of the auxiliary control means, the information being recorded when the activation element and the auxiliary control means have both been actuated.

Advantageously, the neutralizing method includes, after the recording step, a step for resetting the neutralizing means, in particular using a display screen and a man/machine interface including buttons making it possible to enter a reset code.

The invention will be better understood using the following description, provided solely as an example and done in reference to the appended figures, in which:

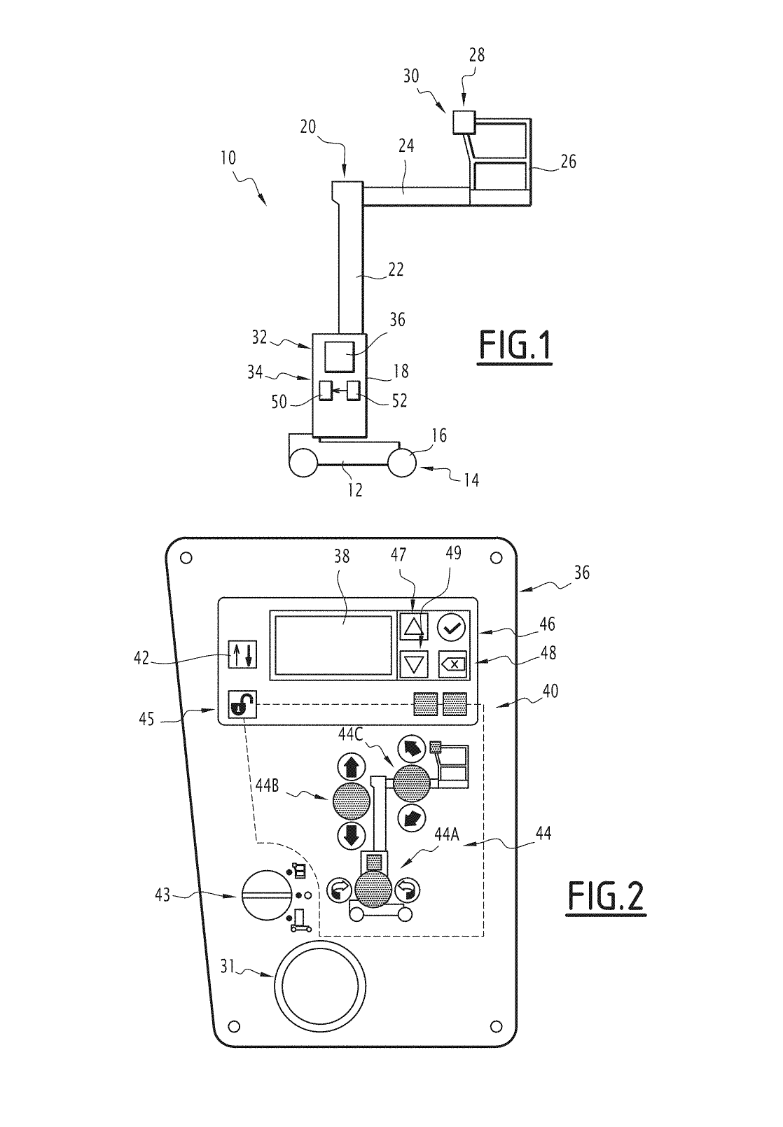

FIG. 1 schematically shows a profile view of a works machine according to one example embodiment of the invention;

FIG. 2 shows an interface panel equipping means for neutralizing a safety shutdown state of the works machine of FIG. 1;

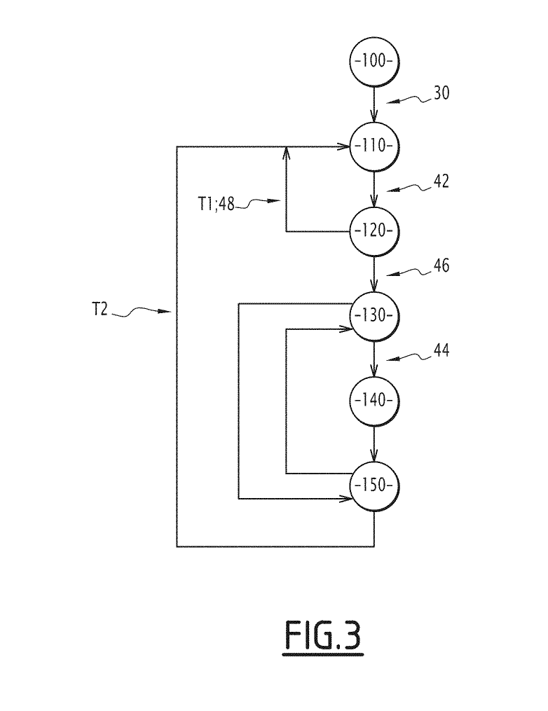

FIG. 3 schematically shows the steps of a method for neutralizing a safety shutdown state of the works machine of FIG. 1.

FIG. 1 shows a works machine 10 according to one example embodiment of the invention. Such a works machine 10 is a device for lifting a person, also called an aerial lift.

Such a lifting device 10 traditionally includes a chassis 12, mounted on moving means 14, in particular comprising wheels 16. The works machine 10 further includes a turret 18, mounted rotating around a vertical axis relative to the chassis 12.

The turret 18 bears an arm 20, for example a two-part arm 20, including a first vertical arm part 22, rising from the turret 18 parallel to said vertical axis, and a second arm part 24, connected movably on the first arm part 22, both in translation along a vertical direction parallel to said vertical axis, and in rotation around an axis perpendicular to the vertical direction. The first arm part 22 is for example formed by a telescoping vertical arm, deployable in the direction of the vertical axis between a position retracted in the turret 18, and a deployed position.

The second arm part 24 bears a platform 26, connected to this second arm part 24 in an articulated manner, such that this platform 26 remains horizontal irrespective of the incline of the second arm part 24 relative to the first arm part 22.

The platform 26 includes primary control means 28, able to be actuated by a user present on this platform 26, making it possible to control various functions of the machine 10, in particular the movements of the movement means 14, the turret 18 and the arm 20.

Traditionally, the works machine 10 includes safety devices 30.

The safety devices 30 for example include a load limiter of the traditional type, able to switch the machine 10 from a normal operating state to a safety shutdown state when the weight of the load carried by the platform 26 exceeds a predetermined value.

Alternatively or additionally, the safety devices 30 include a user safety device, able to switch the machine 10 from the normal operating state to the safety shutdown state when a loss of consciousness of the user or an impact against the user on the platform 26 is detected.

Alternatively or additionally, the safety devices 30 include a first emergency stop switch, for example arranged along the primary control means 28, able to be actuated by the user present on the platform 26 to switch the machine 10 from the normal operating state to the safety shutdown state.

Alternatively or additionally, the safety devices 30 include a second emergency stop switch 31, for example arranged on the turret 18, able to be actuated by a person on the ground to switch the machine 10 from the normal operating state to the safety shutdown state.

All of these safety devices 30 are traditional and will therefore not be described in more detail.

When the machine 10 is in a safety shutdown state while a user is on the platform 26, and more particularly when this user has lost consciousness, it is necessary to return the platform 26 to within reach of the ground in order to rescue the user. However, in the safety shutdown state, all of the functions of the machine 10 are cut, preventing this machine 10 from being controlled.

Thus, the works machine 10 includes means 32 for neutralizing the safety shutdown state, able to switch the machine from said safety shutdown state to a forced operation state. The neutralizing means 32 therefore make it possible to override the safety shutdown state.

These neutralizing means 32 include a computer device 34, in particular comprising an interface panel 36, shown in more detail in FIG. 2. This interface panel 36 includes a display monitor 38 and a man-machine interface 40 connected to this display screen 38.

It should be noted that the second emergency stop switch 31 is for example also arranged on this interface panel 36.

The machine 10 includes auxiliary control means 44, for example accessible from the interface panel 36. These auxiliary control means 44 include various actuators controlling the movements of the machine 10. For example, the auxiliary control means 44 include a first actuator 44A controlling the rotation of the turret 18 around a vertical axis, a second actuator 44B controlling the deployment of the first arm part 22 toward the vertical axis, and a third actuator 44C controlling the incline of the second arm part 24 relative to the first arm part 22. Indicators relative to the different movements that can be controlled by these actuators 44A, 44B, 44C can be displayed on the panel 36 in order to facilitate its use.

In the normal operating state, the primary control means 28 are used to control the machine 10. It will be noted that the auxiliary control means 44 generally do not include an actuator controlling the movement means 14, since their role is solely to control the platform 26 for maintenance operations of the machine 10 or to provide assistance to a user on this platform 26.

The interface panel 36 includes a selection element 43, generally able to be actuated by a key, which may assume three positions, namely:
a neutral position, in which the key can be inserted or removed, and in which neither the primary control means 28 nor the auxiliary control means 44 can be actuated,
a high position, in which the primary control means 28 can be actuated, and the auxiliary control means 44 cannot be actuated, and
a low position, in which the auxiliary control means 44 can be actuated, and the primary control means 28 cannot be actuated.

The high and low positions are only accessible if the key is inserted into the selection element 43.

This selection element 43 makes it possible to determine whether the primary control means 28 or the auxiliary control means 44 exclusively are allowing the control of the machine 10.

The computer device 34 also includes an activation element 45 making it possible, when it is actuated and held, to unlock the auxiliary control means 44. This activation element 45 is for example an activation button 45 arranged on the interface panel 36. Thus, it is only possible to use the auxiliary control means 44 when the activation button 45 is held, which in particular makes it possible to prevent accidental activations of the auxiliary control means 44.

However, it should be noted that the activation element 45 is ineffective when the machine is in the safety shutdown state after a safety device 30 has been triggered. Thus, in case of safety shutdown, it is necessary to switch to the forced operating state to allow the actuation of the activation element 45, therefore to allow the use of the auxiliary control means 44.

The computer device 34 includes a second activation element 42 making it possible, when it is actuated, to switch the machine 10 from the safety shutdown state to the forced operating state. This activation element 42 is for example an activation button 42 arranged on the interface panel 36.

The interface panel 36 advantageously includes other elements that can be actuated, for example a confirmation button 46, a cancellation button 48 and selection buttons 47 and 49, for example “high” and “low” selection buttons.

The neutralizing means 32 also include a memory device 50, and means 52 for recording, in this memory device 50, information according to which the activation element 42 has been actuated.

Advantageously, the recording means 52 are configured to record said information in the memory device 50 only when the activation element 42 and the auxiliary control means 44 have both been actuated. Precise monitoring of the neutralizing means 32 is then ensured, indicating only when the neutralizing means 32 have actually been used to move the platform 26.

Advantageously, the computer device 34 includes means for displaying information according to which the activation element 42 has been actuated, or in the preferred alternative, according to which both the activation element 42 and the auxiliary control means 44 have been actuated. These display means are for example formed by the display monitor 38.

The information recorded in the memory device 50, and the indication displayed by the display means 38, can be binary, in which case they indicate only whether the neutralizing means 32 have been used.

Alternatively, this information and this indication are developed, and for example indicate the date and/or time at which the overriding means 32 were used, and/or whether the safety shutdown state was caused by the load limiter, the user safety device, the first or second emergency stop switch, and/or what movements were made by the auxiliary control means 44.

It should be noted that the actuation of the first or second emergency stop switch results in powering off the machine 10. Thus, advantageously, the neutralizing means 32 are powered from a power source via a connection able to be kept active even if one of the first and second emergency stop switches is actuated. Thus, the neutralizing means 32 can be used to power the machine 10 back on without requiring a reset of the emergency stop switches of this works machine 10.

A method for overriding a safety shutdown state of the works machine 10 will now be described, in particular in reference to FIG. 3.

The method includes an initial step 100, corresponding to the normal operating state of the works machine 10.

When the safety devices 30 are activated, whether by the load limiter, the user safety device, the first or second 31 emergency stop switch, one continues to a step 110 in which the works machine 10 is in the safety shutdown state.

In order to rescue a user present on the platform 26, the activation element 42 is actuated to activate the neutralizing means 32.

One then continues to a step 120 for awaiting confirmation that the neutralizing means 32 have been activated. During this step 120, the display monitor 38 indicates that the forced operating state is about to be activated, and requests confirmation or cancellation. This confirmation or cancellation is done by actuating the confirmation button 46 or the cancellation button 48.

If the cancellation button 48 is actuated, or at the end of a time delay T1, lasting 7 seconds, the computer device 34 considers that the command to neutralize the safety shutdown is canceled, and the method returns to step 110, while awaiting a reset of the machine 10.

Conversely, if the confirmation button 46 is actuated, the method goes on to a step 130 in which the works machine 10 is in the forced operating state. The display monitor 38 then indicates that the machine 10 is in this forced operating state. Furthermore, the activation element 45 and the auxiliary control means 44 are made usable.

Indeed, in this forced operating state, the movements of the machine 10 are authorized, by the activation element 45 and the auxiliary control means 44, despite the safety shutdown state that has been activated, in particular to return the platform 26 to within reach of the ground. In this forced operating state, the speed of the movements is preferably reduced.

In the case where the safety shutdown state is due to the load limiter, an indicator that the maximum load has been exceeded remains active.

As a result of the movements controlled by the auxiliary control means 44, the method continues on to a step 140, during which the recording means 52 record information in the memory 50. This information for example includes the date and/or time at which the overriding means 32 were used, and/or whether the safety shutdown state was caused by the load limiter, the user safety device, the first or second emergency stop switch, and/or what movements were made by the auxiliary control means 44.

After this step 140, the display means 38 can also display an indication that the forced operating state has been activated. This indication can also alternatively also include the date and/or time at which the overriding means 32 were used, and/or whether the safety shutdown state was caused by the load limiter, the user safety device, the first or second emergency stop switch, and/or what movements were made by the auxiliary control means 44.

After the auxiliary control means 44 are actuated, the method continues on to a waiting step 150, during a time delay T2, for example a period of 7 seconds, during which it is possible to actuate the auxiliary control means 44 again. In this case, the method returns to step 130, then, when the auxiliary control means 44 are no longer actuated, returns to step 150 for a new time delay T2.

At the end of this time delay T2, the method returns to step 110, in which the machine is in the safety shutdown state. The machine 10 will next need to be reset traditionally.

Furthermore, the neutralizing means 32 must also be reset, by a qualified operator. As long as this reset has not been done, said indication may remain displayed on the display monitor 38, or be displayed temporarily, in particular when the machine 10 is powered on. Advantageously, the reset is done by entering a specific reset code via the display means 38, the confirmation button 46, the cancellation button 48 and the selection buttons 47 and 49.

It will be noted that the invention is not limited to the embodiment described above, and could assume various alternatives.

In particular, the invention could be applicable to any type of works machine capable of switching to a safety shutdown state.

1-10. (canceled)

11. A works machine with an aerial lift, including:
safety devices, able to switch the machine from a normal operating state to a safety shutdown state,
a platform equipped with primary control means, able to control the machine in the normal operating state,
a safety shutdown state neutralizer for neutralizing the safety shutdown state, comprising an activation element, able to switch the machine from the safety shutdown state to a forced operation state when it is actuated, and
an auxiliary controller of the works machine, able to be manipulated from the ground, capable of controlling the works machine in the forced operating state when it is actuated,
wherein the safety shutdown state neutralizer includes a computer device comprising:
the activation element,
a memory device, and
a recorder for recording, in the memory device, information according to which the activation element has been actuated.

12. The works machine according to claim 11, wherein the recorder is configured to record the information in the memory device only when the activation element and the auxiliary controller have both been actuated.

13. The works machine according to claim 11, wherein the computer device includes a display screen and a man/machine interface.

14. The works machine according to claim 11, wherein the computer device includes a display element for displaying information according to which the activation element and/or the auxiliary controller have been actuated.

15. The works machine according to claim 11, wherein the safety shutdown state neutralizer is powered by a power source via a connection able to be maintained even in case of safety shutdown of the works machine.

16. The works machine according to claim 11, wherein the safety devices include at least one emergency stop switch, able to switch the works machine from the normal operating state to the safety shutdown state when it is actuated, and wherein the safety shutdown state neutralizer is powered by a power source via a connection able to be maintained even in case of safety shutdown caused by the emergency stop switch.

17. The works machine according to claim 11, wherein the safety devices include at least one of the following:
a load limiter, able to switch the works machine from the normal operating state to the safety shutdown state when the mass of the load supported by the platform exceeds a predetermined value, and/or
a user safety device, able to switch the works machine from the normal operating state to the safety shutdown state when a loss of consciousness of an user is detected, and/or
at least one emergency stop switch, able to switch the works machine from the normal operating state to the safety shutdown state when it is actuated.

18. The works machine according to claim 17, wherein the information recorded in the memory device indicates at least one of the following indications:
whether the safety shutdown state was caused by the load limiter, the user safety device or the emergency stop switch, and/or
on what date and/or at what time the activation element and/or the auxiliary controller were actuated, and/or
what movements were made by the auxiliary controller.

19. A neutralizing method for neutralizing a safety shutdown state of a works machine with an aerial lift, the works machine including:
safety devices, able to switch the machine from a normal operating state to a safety shutdown state,
a platform equipped with primary control means, able to control the machine in the normal operating state,
a safety shutdown state neutralizer for neutralizing the safety shutdown state, comprising an activation element, able to switch the machine from the safety shutdown state to a forced operation state when it is actuated, and
an auxiliary controller of the machine, able to be manipulated from the ground, capable of controlling the machine in the forced operating state when it is actuated, wherein the safety shutdown state neutralizer includes a computer device comprising:
the activation element,
a memory device, and
a recorder for recording, in the memory device, information according to which the activation element has been actuated,
wherein the neutralizing method includes:
actuating the activation element, and
recording, in the memory device, information according to which the activation element has been actuated.

20. The neutralizing method according to claim 19, including, after actuating the activation element, activating auxiliary controller, and wherein the recording follows the activation of the auxiliary controller, the information being recorded when the activation element and the auxiliary controller have both been actuated.

21. The neutralizing method according to claim 19, including, after the recording, resetting the safety shutdown state neutralizer, in particular using a display screen and a man/machine interface including buttons making it possible to enter a reset code.
